(19) United States
(12) Patent Application Publication
(10) Pub. No.: US 2021/0246920 A1
(43) Pub. Date: Aug. 12, 2021

(54) SPRING LEAF AND A MANUFACTURING METHOD OF MAKING THE SPRING LEAF

(71) Applicant: CONCRAFT HOLDING CO., LTD., Grand Cayman (KY)

(72) Inventors: Kuo-Chi LEE, New Taipei City (TW); Chin-Hsing LEE, New Taipei City (TW); Lei CHENG, Kunshan City (CN)

(21) Appl. No.: 16/842,192

(22) Filed: Apr. 7, 2020

(30) Foreign Application Priority Data
Feb. 11, 2020 (TW) 109104193

(51) Int. Cl. F16B 2/04

(52) U.S. Cl. CPC F16B 2/04; F16F 1/18

(57) ABSTRACT

A spring leaf and a manufacturing method of making the spring leaf are disclosed. The spring leaf is installed in a casing to replace a butting part on the casing. The spring leaf includes at least a pole, at least an elastic connector, at least an elastic arm, a contact part which contacts the butting part, and a connecting part which is formed between the elastic arm and the contact part by injection molding. The contact part rotates between a positioning location and an escaping location in the casing through an elastic resetting function which is generated by the elastic arm, so as to quickly replace the butting part on the casing.

### BACKGROUND OF THE INVENTION

### a) Field of the Invention

The present invention relates to a spring leaf, and more particularly to a spring leaf which is provided with a better structural strength and an extended service life.

### b) Description of the Prior Art

Referring to FIGS. 1 to 3, it shows a conventional spring leaf. The spring leaf A is installed in a casing B of wireless earphone to quickly replace an ear plug C on the casing B. The spring leaf A includes an elastic part A1 which is roughly in an S-shape and two fixed parts A2 which are disposed on the elastic part A1 respectively; whereas, a center of the elastic part A1 is provided with a pole A3. Two sides of the pole A3 are provided respectively with an elastic arm A4, and each elastic arm A4 is connected with the pole A3 through an elastic connector A5, so that the two elastic arms A4 can result in an elastic resetting function on two sides of the pole A3 through the elastic connector A5 respectively. In addition, each fixed part A2 is disposed on each elastic arm A4.

When the spring leaf A is disposed in the casing B, each fixed part A2 is protruded outside the casing B, and the ear plug C is provided with a fastener C1 to snap the ear plug C on the casing B. In addition, the fastener C1 is provided with a latching slot C2 at a location corresponding to the fixed part A2, and each latching slot C2 is used for latching the fixed part A2, thereby fixing the ear plug C on the casing B.

Upon replacing the ear plug C, the ear plug C only needs to be pulled upward to drive the fastener C1 to escape from the casing B gradually, so that the latching slot C2 can escape from the latching of fixed part A2 gradually. At this moment, the fixed part A2 will be abutted by the fastener C1 to displace toward the interior of casing B and drive the elastic arm A4 to rotate in the casing B simultaneously, thereby replacing the ear plug C.

It is worth mentioning that the fixed part A2 on the spring leaf A is directly formed on the elastic arm A4 by injection molding, and the fixed part A2 is made of plastic; whereas, the fastener C1 is also made of plastic. Therefore, after the fastener C1 and the fixed part A2 undergo a long time of friction, the fixed part A2 and the fastener C1 can be worn out easily, thereby preventing the ear plug C from being fixed on the casing B effectively.

Therefore, in order to achieve the requirement of waterproofing for the existing wireless earphone, the casing B itself is designed hermetically, which allows the spring leaf A not to be replaceable after installing the spring leaf A in the casing B. In addition, after the fixed part A2 is worn out, the ear plug C cannot be even fixed on the casing B effectively that the entire wireless earphone cannot be used, which not only wastes the resources but also does not comply with the usage effectiveness.

Accordingly, how to provide a spring leaf to improve the abovementioned issues is to be solved by the present invention.

### SUMMARY OF THE INVENTION

The primary object of the present invention is to provide a spring leaf, and more particularly to a spring leaf which is installed in a casing to quickly replace a butting part on the casing, and is provided with a better structural strength as well as an extended service life.

To achieve the abovementioned object, the present invention first discloses a spring leaf with a better strength. The spring leaf is installed in a casing to replace a butting part on the casing. The spring leaf includes an elastic part, at least a contact part and a connecting part. The elastic part is provided with at least a pole, at least an elastic connector which is extended from the pole, and at least an elastic arm which is extended from the elastic connector, allowing the elastic arm to conduct an elastic resetting function along the pole through the elastic connector. The contact part contacts the butting part. The connecting part is formed between the elastic arm and the contact part by injection molding, allowing the contact part to be fixed on the elastic arm through the connecting part. In addition, the contact part rotates between a positioning location and an escaping location through the elastic resetting function, wherein when the contact part is at the positioning location, the butting part will be fixed on the casing; whereas, when the contact part is pushed by the butting part to rotate from the positioning location to the escaping location, the butting part will be removed from the casing.

In an embodiment, the hardness of contact part is larger than that of butting part.

In an embodiment, the contact part is made of metal, whereas the butting part is made of plastic.

In an embodiment, the contact part is formed by metal injection molding (MIM).

In an embodiment, a latching structure is disposed between the contact part and the connecting part to latch the contact part with the connecting part.

In an embodiment, the latching structure includes a first latching part which is disposed on the contact part, and a second latching part which is disposed on the connecting part, allowing the contact part to be fixed on the connecting part through the latching between the first latching part and the second latching part.

In an embodiment, the connecting part encloses the elastic arm.

To achieve the abovementioned object, the present invention also discloses a manufacturing method of making the spring leaf. The manufacturing method includes a first forming step and a second forming step. In the first forming step, a first mold is provided first. An interior of the first mold is provided with a first forming space, and metal-plastic powder is injected into the first forming space, so as to form a green part in the first forming space. Next, sintering is conducted to the green part to remove plastic powder in the green part, thereby forming a contact part. In the second forming step, a second mold is provided, and an interior of the second mold is provided with a second forming space. Next, the elastic part and the contact part are put into the second mold, with the elastic part being provided with a pole, at least an elastic connector and at least an elastic arm. This allows part of the elastic arm and part of the contact part to be exposed in the second forming space. In addition, a forming material is injected into the second forming space, so that after the forming material is cooled down and formed in the second forming space, a connecting part is formed between the elastic arm and the contact part, thereby forming the spring leaf.

In an embodiment, the contact part further includes a first latching part which is disposed in the second forming space.

In an embodiment, an end of the connecting part is provided with a second latching part which encloses the first latching part, and the other end of contact part encloses the elastic arm.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional spring leaf.

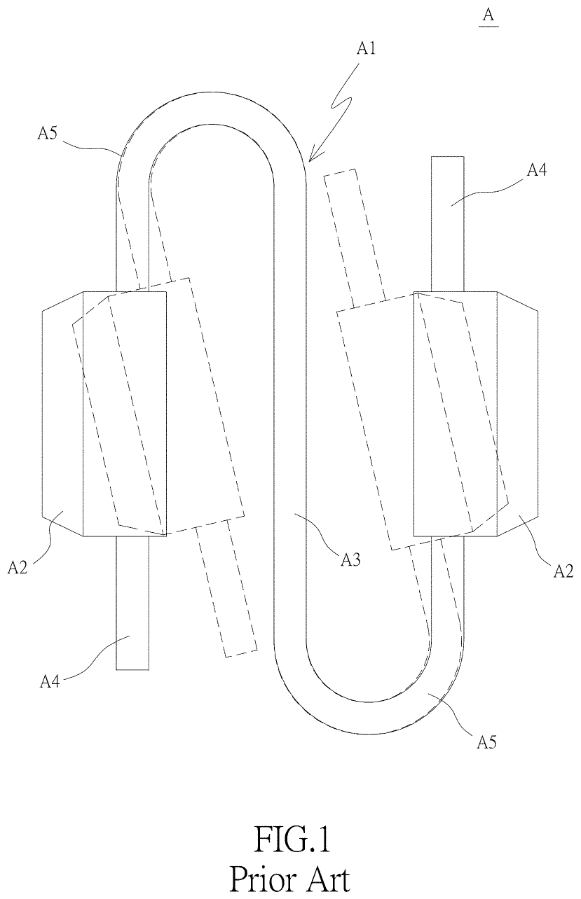

FIG. 2 shows a cutaway view where the conventional spring leaf is at a positioning location.

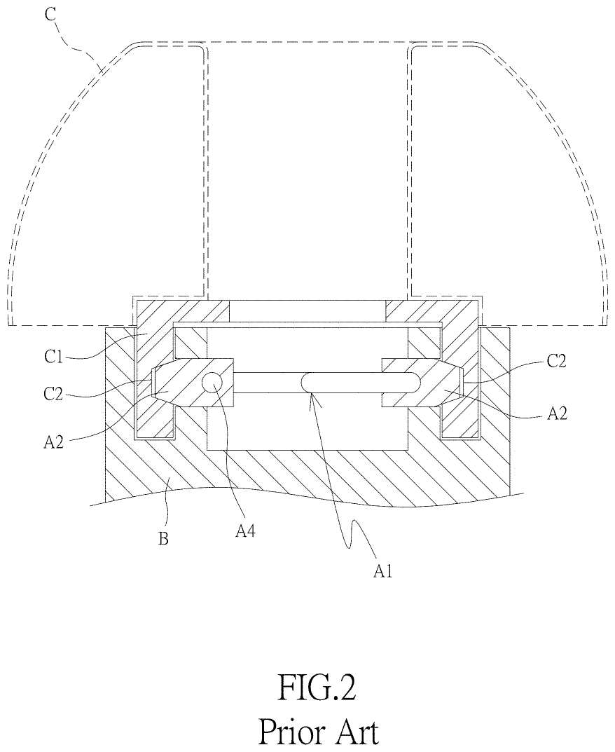

FIG. 3 shows a cutaway view where the conventional spring leaf is at an escaping location.

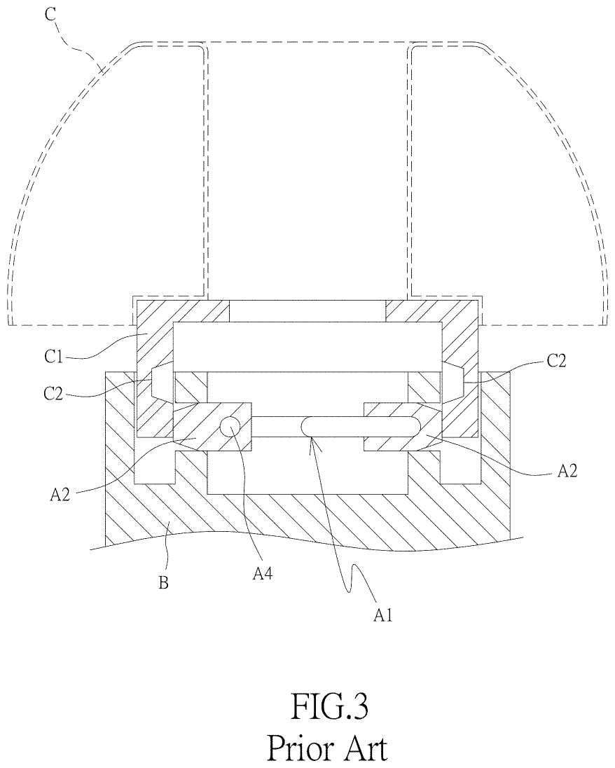

FIG. 4 shows a cutaway view of a spring leaf, according to the present invention.

FIG. 5 shows an exploded view of the spring leaf, according to the present invention.

FIG. 6 shows a cutaway view where the spring leaf is at a positioning location, according to the present invention.

FIG. 7 shows a cutaway view where the spring leaf is at an escaping location, according to the present invention.

FIG. 8 shows a flow diagram of manufacturing process, according to the present invention.

FIG. 9 shows a cutaway view of a first mold, according to the present invention.

FIG. 10 shows a cutaway view of a second mold, according to the present invention.

### DETAILED DESCRIPTION OF THE PREFERRED EMBODIMENTS

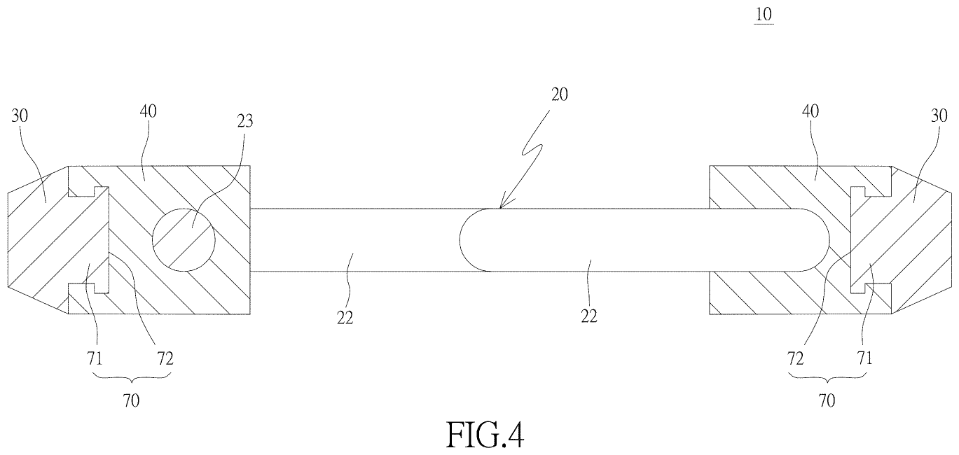

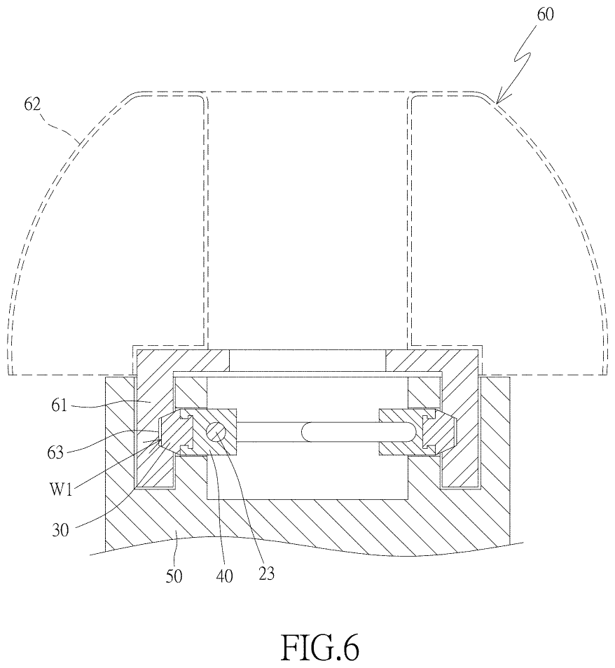

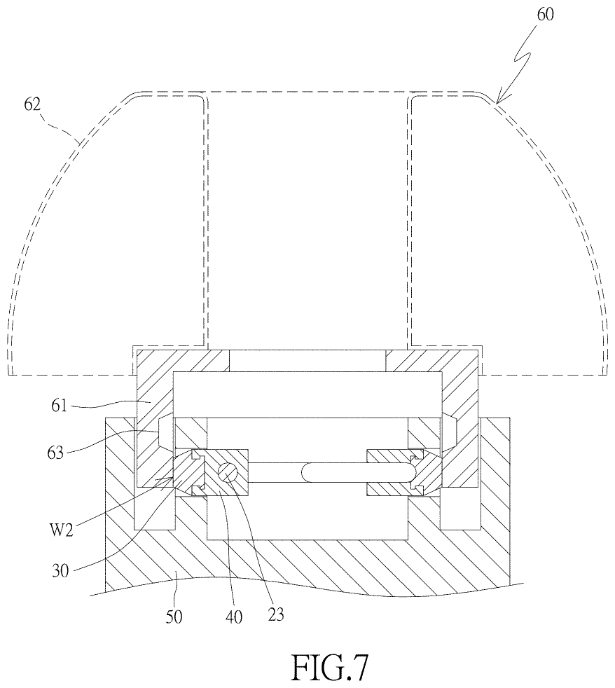

Referring to FIGS. 4 to 7, the present invention discloses first a spring leaf with a better strength. The spring leaf 10 is installed in a casing 50 to quickly replace a butting part 60 on the casing 50. The spring leaf 10 comprises an elastic part 20, at least a contact part 30 and at least a connecting part 40. In the present embodiment, the casing 50 is a wireless earphone; whereas, the butting part 60 is an ear plug and is constituted by a fastener 61 and a plug body 62 which is formed on the fastener 61. By the fastener 61, the butting part 60 can be replaced quickly on the casing 50 through the spring leaf 10.

The elastic part 20 is provided with a pole 21, at least an elastic connector 22 which is extended from the pole 21, and at least an elastic arm 23 which is extended from the elastic connector 22. In the present embodiment, two ends of the pole 21 are extended respectively with an elastic connector 22, and each elastic connector 22 is extended with an elastic arm 23. The elastic part 20 is formed integrally by a metallic rod, and each elastic arm 23 is provided with an elastic resetting function on the pole 21 through the elastic connector 22.

The contact part 30 is extended outside the casing 50 to quickly replace the butting part 60 on the casing 50. The hardness of contact part 30 is larger than that of fastener 61 in the butting part 60. In the present embodiment, the contact part 30 is formed by MIM, and the fastener 61 is made of plastic.

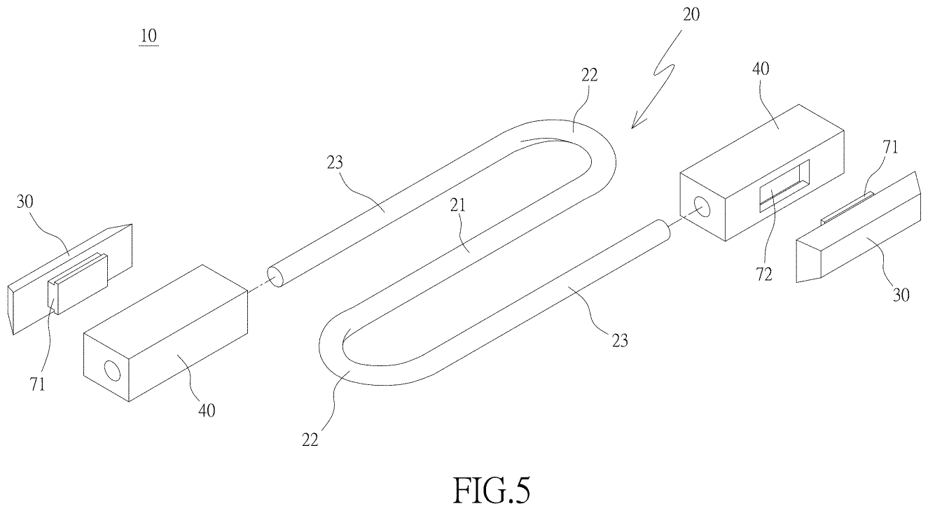

The connecting part 40 is formed between each elastic arm 23 and each contact part 30 by injection molding, so as to fix each contact part 30 on each elastic arm 23. As shown in FIG. 5, for the ease of description, the connecting part 40, the elastic arm 23 and the contact part 30 are separated. In practical application, however, the connecting part 40 is directly formed between the elastic arm 23 and the contact part 30, allowing each contact part 30 to rotate between a positioning location W1 and an escaping location W2 through the elastic resetting function which results from each connecting part 40 and each elastic arm 23.

It is worth mentioning that to effectively combine the contact part 30 with the connecting part 40, each contact part 30 is combined with each connecting part 40 by a latching structure 70. The latching structure 70 includes a first latching part 71 which is disposed on the contact part 30, and a second latching part 72 which is disposed on the connecting part 40. The first latching part 71 can be latched with the second latching part 72, allowing the connecting part 40 to be latched with the contact part 30 effectively. In the present embodiment, the first latching part 71 is protruded on the contact part 30 and is extended toward the elastic arm 23; whereas, the second latching part 72 is concaved on the connecting part 40. Therefore, when the connecting part 40 is directly formed between the elastic arm 23 and the contact part 30 by injection molding, the connecting part 40 can enclose the first latching part 71, which forms the second latching part 72 on the connecting part 40, so that the contact part 30 can be fixed on the connecting part 40 through the latching between the first latching part 71 and the second latching part 72.

Furthermore, when the spring leaf 10 of the present invention is applied inside the casing 50, the contact part 30 is protruded outside the casing 50; whereas, when the butting part 60 is fixed on the casing 50 through the fastener 61, a latching slot 63 is disposed on the fastener 61 at the location of each contact part 30 to latch the contact part 30, allowing each contact part 30 to be latched into each latching slot 63, so that the butting part 60 can be fixed on the casing 50. At this time, the contact part 30 is protruded outside the casing 50 and is latched into the latching slot 63, thereby being disposed on the positioning location W1. On the other hand, upon replacing the butting part 60, the butting part 60 is just pulled upward to drive the fastener 61 upward, allowing the latching slot 63 to escape from the contact part 30 gradually. In addition, the contact part 30 is pushed by the fastener 61 to rotate inside the casing 50, allowing the contact part 30 to rotate to the escaping location W2 that the butting part 60 can escape from the casing 50 to replace the butting part 60.

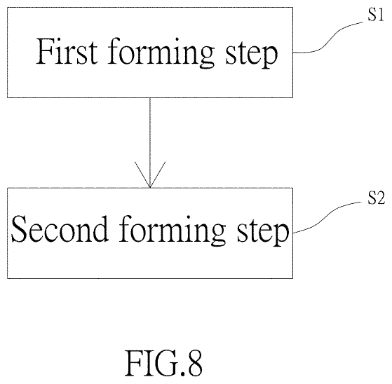

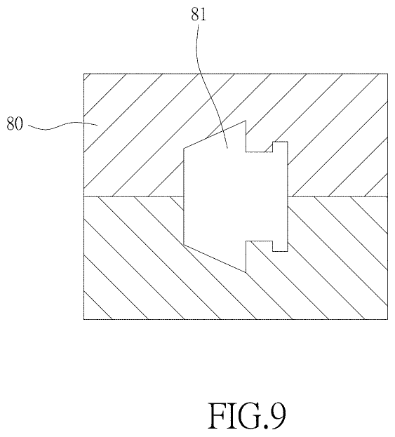

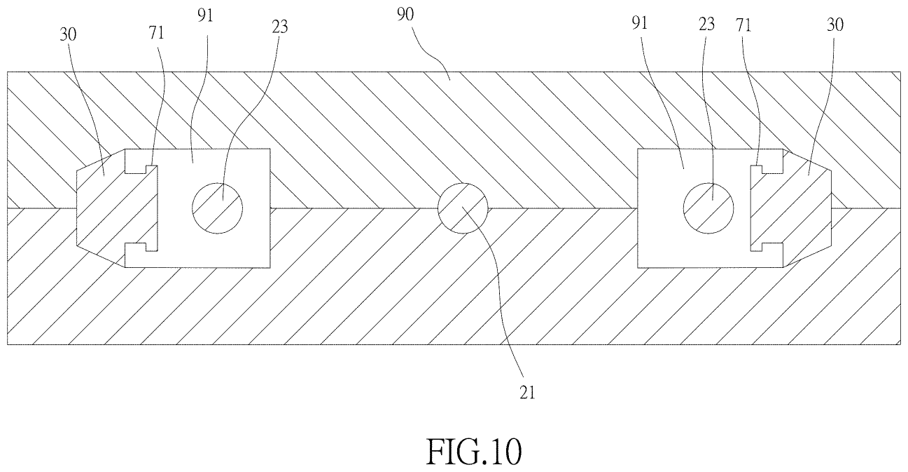

In addition, referring to FIG. 5 and FIGS. 8 to 10, the present invention also discloses a manufacturing method of making the spring leaf 10. The manufacturing method comprises a first forming step S1 and a second forming step S2. The first forming step S1 is used primarily to from the abovementioned contact part 30. According to the previous descriptions, the contact part 30 is formed by MIM. Therefore, in the present embodiment, a first mold 80 is provided first, and an interior of the first mold 80 is provided with a first forming space 81. Next, metal-plastic powder is injected into the first forming space 81 to form a green part, and the green part is removed for high-temperature sintering after forming, which forms the contact part 30 after melting the plastic powder inside the green part. In addition, the first latching part 71 is formed on the contact part 30. As entire spring leaf 10 is small in size, the contact part 30 that is formed by MIM can be even smaller.

The second forming step S2 is used to form the connecting part 40. In the second forming step S2, a second mold 90 is provided first, and an interior of the second mold 90 is provided with a second forming space 91. Next, the abovementioned elastic part 20 and contact part 30 are put into the second forming space 91 at a same time, with that part of elastic arm 23 on the elastic part 20 and the first latching part 71 on the contact part 30 are exposed in the second forming space 91. Then, a forming material (plastic in the present embodiment) is injected into the second forming space 91, allowing the forming material to enclose part of the elastic arm 23 and the first latching part 71 in the second forming space 91, thereby forming the second latching part 72 on the connecting part 40 to latch with the first latching part 71 (as shown in FIG. 5). Finally, the spring leaf 10 can be formed after the forming material is cooled down and formed in the second forming space 91.

Accordingly, referring to all the drawings, as the contact part 30 is made of metal, when the contact part 30 rotates between the positioning location W1 and the escaping location W2 in the casing 50 through the elastic arm 23 and the connecting part 40, due to that the hardness of contact part 30 is larger than that of fastener 61, the contact part 30 will not be worn out under a long time of use, thereby providing the spring leaf 10 with a better strength. In addition, even that the fastener 61 is worn out after being used for a long time, only the butting part 60, which is provided with a lower cost, needs to be replaced. Besides that, the spring leaf 10 will not be damaged after the butting part 60 is worn out, thereby extending the service life of spring leaf 10.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A spring leaf, which is installed in a casing to replace a butting part on the casing, comprising:
an elastic part, which is provided with a pole, an elastic connector extending from the pole, and an elastic arm extending from the elastic connector, allowing the elastic arm to conduct an elastic resetting function along the pole through the elastic connector;
a contact part which contacts the butting part; and
a connecting part, which is formed between the elastic arm and the contact part by injection molding, allowing the contact part to be fixed on the elastic arm by the connecting part, and the contact part to rotate between a positioning location and an escaping location through the elastic resetting function;
wherein when the contact part is at the positioning location, the butting part is fixed on the casing, and when the contact part is pushed by the butting part to rotate from the positioning location to the escaping location, the butting part is removed from the casing.

2. The spring leaf according to claim 1, wherein the hardness of contact part is larger than that of butting part.

3. The spring leaf according to claim 2, wherein the contact part is made of metal, and the butting part is made of plastic.

4. The spring leaf according to claim 2, wherein the contact part is formed by MIM (Metal Injection Molding).

5. The spring leaf according to claim 1, wherein a latching structure is disposed between the contact part and the connecting part to latch the contact part with the connecting part.

6. The spring leaf according to claim 5, wherein the latching structure includes a first latching part which is disposed on the contact part, and a second latching part which is disposed on the connecting part, allowing the contact part to be fixed on the connecting part by latching the first latching part with the second latching part.

7. The spring leaf according to claim 6, wherein the elastic part encloses the elastic arm.

8. A manufacturing method of forming a spring leaf, comprising steps of:
a) first forming, wherein a first mold is provided first, an interior of the first mold is provided with a first forming space, and metal-plastic powder is injected into the first forming space to form a green part in the first forming space, followed by conducting sintering to the green part to remove the plastic powder in the green part, thereby forming a contact part; and
b) second forming, wherein a second mold is provided, an interior of the second mold is provided with a second forming space, and an elastic part which is provided with a pole, an elastic connector and an elastic arm, as well as the contact part are put into the second mold, exposing part of elastic arm and part of contact part in the second forming space, and then injecting a forming material into the second forming space to form a connecting part between the elastic arm and the contact part after the forming material is cooled down and formed in the second forming space, so as to form the spring leaf.

9. The manufacturing method of forming the spring leaf, according to claim 8, wherein the contact part further includes a first latching part which is disposed in the second forming space.

10. The manufacturing method of forming the spring leaf, according to claim 9, wherein an end of connecting part is provided with a second latching part which encloses the first latching part, and the other end of connecting part encloses the elastic arm.
